(19) United States
(12) Patent Application Publication
(10) Pub. No.: US 2019/0372466 A1
(43) Pub. Date: Dec. 5, 2019

(54) DIRECT BATTERY CONNECTION WITHIN A VOLTAGE REGULATOR SYSTEM

(71) Applicant: QUALCOMM Incorporated, San Diego, CA (US)

(72) Inventor: Didier FARENC, San Diego, CA (US)

(21) Appl. No.: 16/000,773

(22) Filed: Jun. 5, 2018

(51) Int. Cl. H02M 3/158; H02J 7/00

(52) U.S. Cl. CPC H02M 3/1584; H02J 7/0045; H02J 7/0072

(57) ABSTRACT

Aspects of the disclosure are directed to direct battery connection within a voltage regulator system. In accordance with one aspect, distributing power from an internal battery as an active energy source includes receiving a battery voltage from the internal battery through a direct battery voltage connection; receiving a primary load voltage from a power conditioner; and regulating and combining the battery voltage and the primary load voltage using a plurality of phased regulator sections to generate a common output voltage. In one aspect, a power distribution system includes an internal battery to function as an active energy source for a load; a battery switch coupled to the internal battery; a power management integrated circuit (PMIC) coupled to the battery switch; and a direct battery voltage connection coupling the internal battery to the power management integrated circuit and bypassing the battery switch.

### TECHNICAL FIELD

This disclosure relates generally to the field of power distribution, and, in particular, to direct battery connection within a voltage regulator system.

### BACKGROUND

Portable electronic devices (e.g., mobile devices such as mobile phones) operate with two types of energy sources: an internal battery and an external power supply (e.g., AC power line). Typically, a power distribution system connects the energy sources to loads, which provide the device functionality and consume electric energy by drawing electric current. When the internal battery is the active energy source, the battery supplies current to the load through the power distribution system. However, the power distribution system may have resistive power losses which reduces overall energy efficiency. Therefore, a more energy-efficient battery power distribution system is needed when the internal battery is the active energy source for a mobile device.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides direct battery connection within a voltage regulator system. Accordingly, a method for distributing power from an internal battery as an active energy source including receiving a battery voltage from the internal battery through a direct battery voltage connection; receiving a primary load voltage from a power conditioner; and regulating and combining the battery voltage and the primary load voltage using a plurality of phased regulator sections to generate a common output voltage.

In one example, the method further includes providing the common output voltage to a voltage regulator. In one example, the voltage regulator generates a load voltage for a load based on the common output voltage. In one example, the load voltage is generated over a plurality of output voltage rails. In one example, the internal battery is charged from an external power supply through a battery switch. In one example, the direct battery voltage connection bypasses the battery switch. In one example, the primary load voltage is coupled to the battery switch. In one example, the plurality of phased regulator sections is active sequentially at different phase durations. In one example, each of the plurality of phased regulator sections includes one or more of a pair of drivers, a pair of transistors and an inductor. In one example, the pair of transistors for each of the plurality of phased regulator sections is active sequentially at different phase durations. In one example, the pair of drivers for each of the plurality of phased regulator sections is active sequentially at the different phase durations.

Another aspect of the disclosure provides an apparatus for distributing power from an internal battery as an active energy source, the apparatus including means for receiving a battery voltage from the internal battery through a direct battery voltage connection; means for receiving a primary load voltage from a power conditioner; and means for regulating and combining the battery voltage and the primary load voltage using a plurality of phased regulator sections to generate a common output voltage. In one example, the apparatus further includes means for providing the common output voltage to a voltage regulator.

In one example, the apparatus further includes means for generating a load voltage for a load based on the common output voltage. In one example, the apparatus further includes a plurality of output voltage rails, and wherein the load voltage is generated over the plurality of output voltage rails. In one example, the apparatus further includes a battery switch and wherein the internal battery is charged from an external power supply through the battery switch.

In one example, the direct battery voltage connection bypasses the battery switch. In one example, the primary load voltage is coupled to the battery switch. In one example, the plurality of phased regulator sections is active sequentially at different phase durations. In one example, each of the plurality of phased regulator sections includes one or more of a pair of drivers, a pair of transistors and an inductor. In one example, the pair of transistors for each of the plurality of phased regulator sections is active sequentially at different phase durations. In one example, the pair of drivers for each of the plurality of phased regulator sections is active sequentially at the different phase durations.

Another aspect of the disclosure provides a power distribution system includes an internal battery to function as an active energy source for a load; a battery switch coupled to the internal battery; a power management integrated circuit (PMIC) coupled to the battery switch; and a direct battery voltage connection coupling the internal battery to the power management integrated circuit and bypassing the battery switch. In one example, the internal battery includes an indirect battery voltage connection to the power management integrated circuit (PMIC) through the battery switch.

In one example, the power management integrated circuit (PMIC) generates a common output voltage. In one example, the common output voltage is generated by using a phased combination of two PMIC input voltages. In one example, the two PMIC input voltages includes the direct battery voltage connection and the indirect battery voltage connection. In one example, the power distribution system further includes a voltage regulator coupled to the power management integrated circuit (PMIC) to receive the common output voltage. In one example, based on the common output voltage, the voltage regulator provides a plurality of output voltage rails to the load.

Another aspect of the disclosure provides a computer-readable medium storing computer executable code, operable on a device including at least one processor and at least one memory coupled to the at least one processor, wherein the at least one processor is configured to implement distributing power from an internal battery as an active energy source, the computer executable code including instructions for causing a computer to receive a battery voltage from the internal battery through a direct battery voltage connection, wherein the internal battery is charged from an external power supply through a battery switch and wherein the direct battery voltage connection bypasses the battery switch; instructions for causing the computer to receive a primary load voltage from a power conditioner; and instructions for causing the computer to regulate and combine the battery voltage and the primary load voltage using a plurality of phased regulator sections to generate a common output voltage.

These and other aspects of the invention will become more fully understood upon a review of the detailed description, which follows. Other aspects, features, and implementations of the present invention will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of a power distribution system for a mobile device with an external power supply as an active energy source.

FIG. 2 illustrates an example of a power distribution system for a mobile device with an internal battery as an active energy source.

FIG. 3 illustrates an example of a power distribution system for a mobile device with an internal battery as an active energy source with a direct battery connection.

FIG. 4 illustrates an example of a power management integrated circuit (PMIC) with a multi-phase buck converter.

FIG. 5 illustrates an example flow diagram for distributing power from an internal battery as an active energy source.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

A power distribution system may connect energy sources, such as an internal battery or an external power supply (e.g., AC power line), to a load, which consumes electric current. For example, when the external power supply is the active energy source and the internal battery is being charged, a power conditioner (e.g., switch mode battery charger) in the power distribution system converts the external power supply voltage V_{BUS} to a primary load voltage V_{PH}. In one example, the external power supply provides current to the load through the power conditioner. In addition, the power conditioner may adjust the primary load voltage V_{PH} depending on a battery charge state.

In one example, a battery switch (e.g., BATFET) in the power distribution system regulates battery charging current while the external power supply is the active energy source. Also, a power management integrated circuit (PMIC) may produce a plurality of secondary load voltage rails from the primary load voltage V_{PH}.

For example, when the internal battery is the active energy source (i.e., the external power supply is not active), the internal battery supplies current to the load through the battery switch. However, the battery switch may have resistive power losses which reduces overall energy efficiency. That is, a proportion of the battery energy is dissipated in the battery switch in the power distribution system instead of the load.

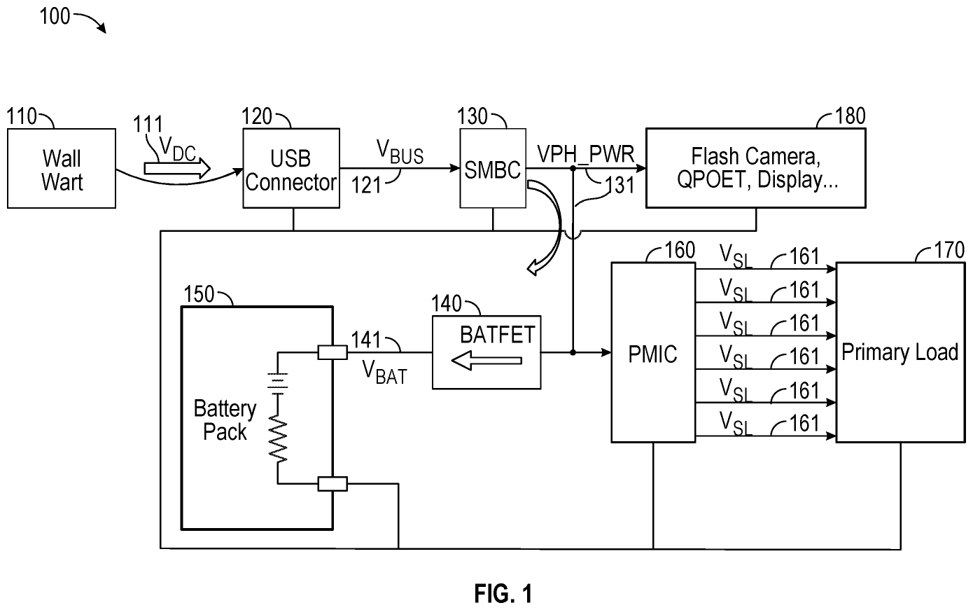

FIG. 1 illustrates an example of a power distribution system 100 for a mobile device with an external power supply as an active energy source. For example, a power converter 110 (e.g., wall wart) converts an alternating current (AC) waveform to a direct current (DC) input voltage V_{DC} 111. Next, the power converter 110 connects to a mobile device external connector 120 (e.g., USB connector) which converts the DC input voltage V_{DC} 111 to an external power supply voltage V_{BUS} 121. In one example, the mobile device external connector 120 connects to a power conditioner 130. In one example, the power conditioner 130 is a switch mode battery charger (SMBC). The power conditioner 130 converts the external power supply voltage V_{BUS} 121 to a primary load voltage VPH_PWR 131. In one example, the power conditioner 130 employs a switch mode to convert the external power supply voltage V_{BUS} 121 to the primary load voltage VPH_PWR 131.

In one example, the power conditioner 130 delivers the primary load voltage VPH_PWR 131 to a battery switch 140 (e.g. BATFET), a power management integrated circuit (PMIC) 160, a direct load 180 (e.g., flash camera, envelope tracker, display, etc.), and other loads. The battery switch 140 delivers a battery voltage V_{BAT} 141 to a battery 150. In one example, the battery voltage V_{BAT} 141 is used for charging the battery 150 by supplying a battery charging current. For example, charging the battery 150 increases a charge level of the battery up to a maximum charge level. In one example, the charge level may be quantified as a percentage and the maximum charge level is defined as 100%. For example, the power conditioner 130 adjusts the primary load voltage VPH_PWR 131 according to the charge level of the battery.

In one example, the battery switch 140 regulates the battery charging current using a charging mode with the external power supply as the active energy source. For example, the charging mode may be a current mode, a voltage mode, or other modes.

In one example, the PMIC 160 produces a plurality of secondary load voltage rails V_{SL} 161 from the primary load voltage VPH_PWR 131. Although six secondary load voltage rails are shown in FIG. 1, one skilled in the art would understand that the quantity of secondary load voltage rails may differ and still be within the scope and spirit of the present disclosure. In one example, the PMIC 160 is a plurality of voltage regulators which conditions the primary load voltage VPH_PWR 131 and converts it to different voltage levels for the secondary load voltage rails V_{SL} 161. The PMIC 160 delivers the secondary load voltage rails V_{SL} 161 to a primary load 170. In one example, the primary load 170 is a system on a chip (SoC) (e.g., mobile station modem (MSM)).

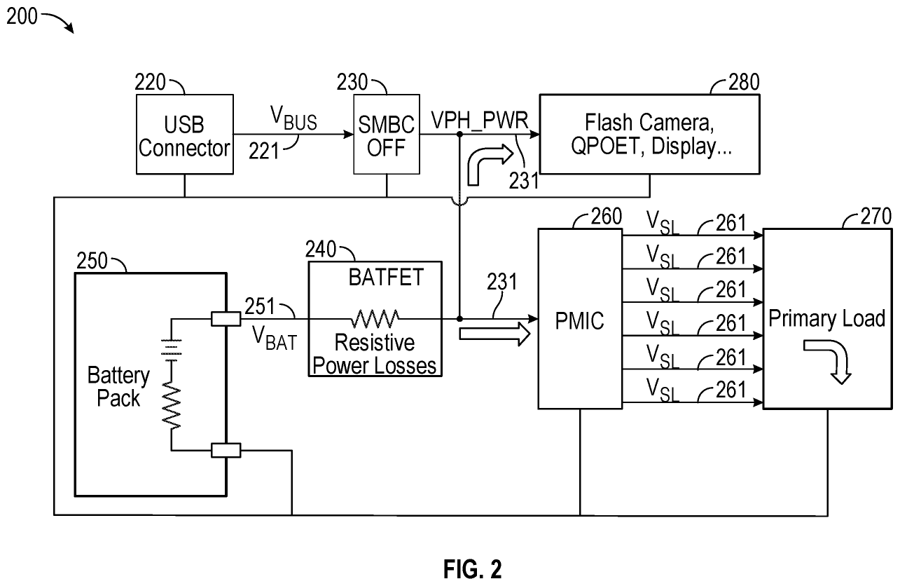

FIG. 2 illustrates an example of a power distribution system 200 for a mobile device with an internal battery as an active energy source. For example, a mobile device external connector 220 (e.g., USB connector) provides an external power supply voltage V_{BUS} 221. In one example, the mobile device external connector 220 connects to a power conditioner 230. In one example, the power conditioner 230 is a switch mode battery charger (SMBC). The power conditioner 230 is in an OFF state when an internal battery 250 is an active energy source. The power conditioner 230 is in an ON state when an external power supply is the active energy source. In one example, the power conditioner 230 may be activated in reverse and supply current to an external device with the internal battery 250 as the active energy source.

In one example, the internal battery 250 serves as an active energy source. For example, the internal battery 250 produces a battery voltage V_{BAT} 251 to a battery switch 240 (e.g., BATFET). In one example, the battery switch 240 is a fully ON switch. In one example, all current from the internal battery 250 passes through the battery switch 240. For example, the battery switch 240 has resistive losses which may reduce energy efficiency of the power distribution system.

In one example, the battery switch 240 produces a primary load voltage VPH_PWR 231 when the internal battery 250 is the active energy source. For example, the battery switch 240 delivers the primary load voltage VPH_PWR 231 to a power management integrated circuit (PMIC) 260, a direct load 280 (e.g., flash camera, envelope tracker, display, etc.), and other loads.

In one example, the PMIC 260 produces a plurality of secondary load voltage rails V_{SL} 261 from the primary load voltage VPH_PWR 231. Although six secondary load voltage rails 261 are shown in FIG. 2, one skilled in the art would understand that the quantity of secondary load voltage rails may differ and still be within the scope and spirit of the present disclosure.

In one example, the PMIC 260 is a plurality of voltage regulators which conditions the primary load voltage VPH_PWR 231 and converts it to different voltage levels for the secondary load voltage rails V_{SL} 261. In one example, the PMIC 260 has one voltage regulator per secondary load voltage rail. Finally, the PMIC 260 delivers the secondary load voltage rails V_{SL} 261 to a primary load 270. In one example, the primary load 270 is a system on a chip (SoC) (e.g., mobile station modem (MSM)).

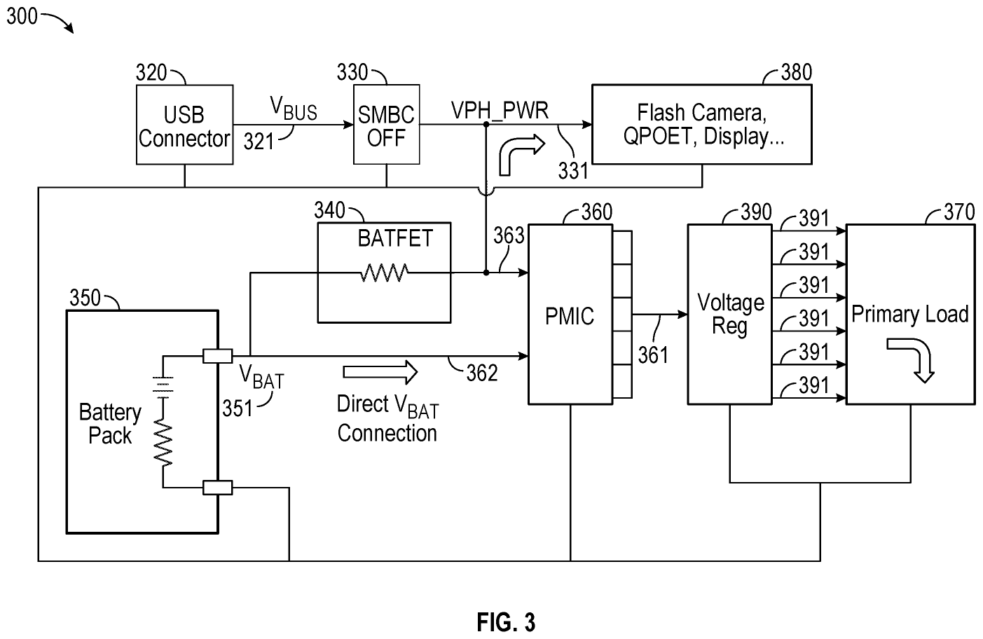

FIG. 3 illustrates an example of a power distribution system 300 for a mobile device with an internal battery as an active energy source with a direct battery connection. For example, a mobile device external connector 320 (e.g., USB connector) provides an external power supply voltage V_{BUS} 321. In one example, the mobile device external connector 320 connects to a power conditioner 330. In one example, the power conditioner 330 is a switch mode battery charger (SMBC). The power conditioner 330 is in an OFF state when an internal battery 350 is an active energy source. The power conditioner 330 is in an ON state when an external power supply is the active energy source.

In one example, the internal battery 350 serves as the active energy source. For example, the internal battery 350 produces a battery voltage V_{BAT} 351 to a battery switch 340 (e.g., BATFET). In one example, the internal battery 350 has a direct battery voltage connection 362 to a power management integrated circuit (PMIC) 360. In one example, the internal battery 350 has an indirect battery voltage connection 363 to the PMIC 360 via the battery switch 340. That is, the PMIC 360 has two PMIC input voltages, the direct battery voltage connection 362 and the indirect battery voltage connection 363.

In one example, the PMIC 360 generates a common output voltage 361 using a phased combination of the two PMIC input voltages. The common output voltage 361 is sent to voltage regulator 390 (e.g., embedded voltage regulator (EVR)) which provides a plurality of output voltage rails 391 to a primary load 370. In one example, the primary load 370 is a system on a chip (SoC) (e.g. mobile station modem (MSM)). Also, in one example, the battery switch 340 delivers the primary load voltage VPH_PWR 331 to a direct load 280 (e.g., flash camera, envelope tracker, display, etc.), and other loads.

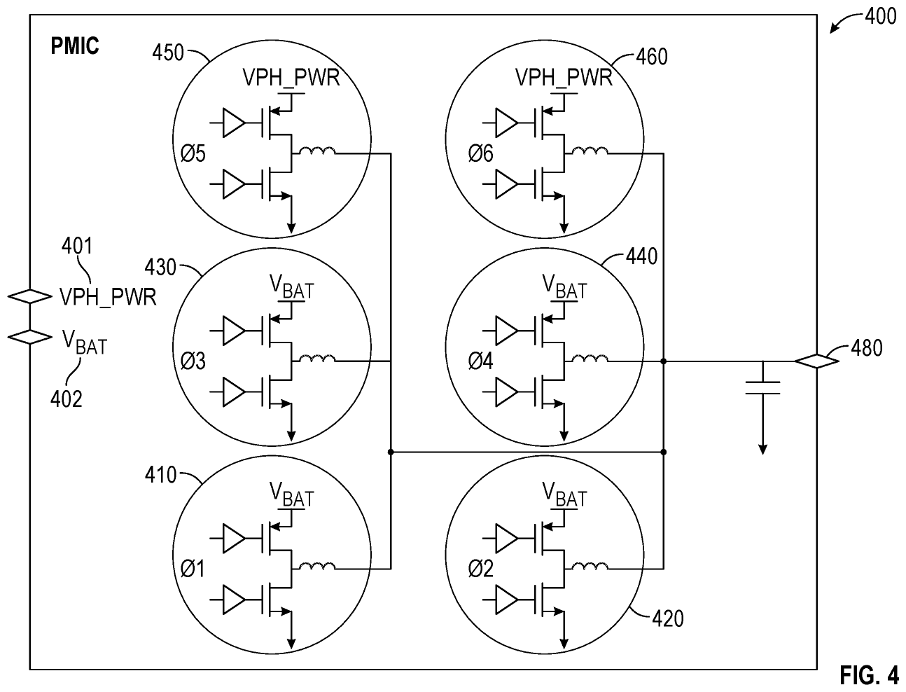

FIG. 4 illustrates an example of a power management integrated circuit (PMIC) 400 with a multi-phase buck converter. In one example, a buck converter converts an input voltage to an output voltage with a lower voltage. In one example, a multi-phase buck converter is a buck converter with multiple sections which are active over different phase durations. In one example, the different phase durations may be overlapping or non-overlapping time intervals over a clock period. In one example, the clock period is a reciprocal of a clock frequency. For example, a clock frequency of 100 MHz has a clock period of 10 nanoseconds. And, a first section may be active during a first phase duration, a second section may be active during a second phase duration, etc.

As shown in the example of FIG. 4, the PMIC 400 has two input voltages, a primary load voltage VPH_PWR 401 and a battery voltage V_{BAT} 402. In one example, the primary load voltage VPH_PWR 401 is coupled to a battery switch (e.g., BATFET, not shown) and is derived from a power conditioner (not shown). In one example, the battery voltage V_{BAT} 402 is directly connected to an internal battery (not shown). For example, the PMIC 400 provides a common output voltage 480 using a phased combination of the two input voltages.

In one example, the PMIC 400 includes a plurality of phased regulator sections which are active sequentially at different phase durations. For example, each section may accept one of the two input voltages (e.g., primary load voltage VPH_PWR 401 or battery voltage V_{BAT} 402) to provide the common output voltage 480. In one example, each section receives the battery voltage V_{BAT} 402 from the internal battery through a direct battery voltage connection. In one example, each section receives the primary load voltage VPH_PWR 401 which is derived from a power conditioner. In one example, the sections regulate and combine the battery voltage and the primary load voltage to generate a common output voltage. In one example, one of the pair of transistors in a section will accept either the battery voltage V_{BAT} 402 or the primary load voltage VPH_PWR 401.

For example, a first section 410, a second section 420, a third section 430 and a fourth section 440 of the PMIC 400 accept the battery voltage V_{BAT} 402 which is directly connected to the internal battery. For example, a fifth section 450 and a sixth section 460 of the PMIC 400 accept the primary load voltage VPH_PWR 401. Other combinations of sections and input voltage acceptance are also possible and within the scope and spirit of the present disclosure. Each section may include a pair of drivers, a pair of transistors and/or an inductor. In one example, the pair of transistors for each section are active sequentially at different phase durations (i.e., non-overlapping time intervals over a clock period). In one example, the pair of drivers for each section are active sequentially at different phase durations (i.e., non-overlapping time intervals over a clock period). For example, an output of each inductor for each section may provide the common output voltage 480.

In one example, when the internal battery is the active energy source, the sections of PMIC 400 which accept the battery voltage V_{BAT} 402 are directly connected to the internal battery for improved energy efficiency. In one example when the internal battery is the active energy source, each regulator section of PMIC 400 which accept the primary load voltage VPH_PWR 401 may be inactive while the remaining regulator sections which connect to the battery voltage V_{BAT} 402 are active. In one example when the internal battery is the active energy source, and when the internal battery is depleted, the regulator section of PMIC 400 which accepts a the primary load voltage VPH_PWR 401 may be active while the remaining sections which connect to the internal battery are inactive. In one example, when an external power supply is the active energy source, the sections of PMIC 400 which accept the primary load voltage VPH_PWR 401 are connected to the battery switch. In one example, the battery switch includes resistive losses with lower energy efficiency. In one example, lower energy efficiency is less important for day of use (DOU) when the internal battery is not the active energy source.

In one example, sections of PMIC 400 connected to the internal battery may be activated first for optimal energy efficiency (e.g. no BATFET losses). In one example, sections of PMIC 400 connected to primary load voltage VPH_PWR 401 may be activated when load requirements are at peak demand. In one example, when battery voltage V_{BAT} 402 is low (i.e., below minimum operating voltage), sections of PMIC 400 connected to primary load voltage VPH_PWR 401 may be activated. In one example, sections of PMIC 400 connected to the internal battery may be inactive when the battery switch (e.g. BATFET) is regulating current from the primary load voltage VPH_PWR 401 until the battery voltage V_{BAT} 402 approximately equals the primary load voltage VPH_PWR 401.

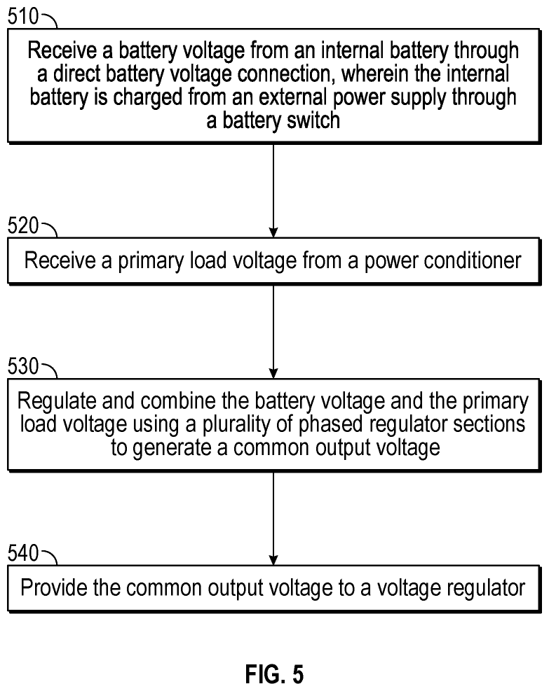

FIG. 5 illustrates an example flow diagram 500 for distributing power from an internal battery as an active energy source. In block 510, receive a battery voltage (e.g. V_{BAT}) from an internal battery through a direct battery voltage connection, wherein the internal battery is charged from an external power supply through a battery switch. In one example, the direct battery voltage connection bypasses the battery switch.

In block 520, receive a primary load voltage (e.g., VPH_PWR) from a power conditioner. In one example, the power conditioner conditions a voltage from the external power supply. In one example, the primary load voltage is coupled to the battery switch.

In block 530, regulate and combine the battery voltage and the primary load voltage using a plurality of phased regulator sections to generate a common output voltage. In one example, the plurality of phased regulator sections is active sequentially at one or more non-overlapping time intervals over a clock period. In one example, the battery voltage and the primary load voltage are regulated by a power management integrated circuit (PMIC) (e.g., PMIC 400 shown in FIG. 4) which includes a plurality of phased regulator sections which are active sequentially at different phase durations. In one example, each of the plurality of phased regulator sections may include one or more of a pair of drivers, a pair of transistors and/or an inductor. In one example, the pair of transistors for each of the plurality of phased regulator sections is active sequentially at different phase durations (i.e., non-overlapping time intervals over a clock period). In one example, the pair of drivers for each of the plurality of phased regulator sections is active sequentially at different phase durations (i.e., non-overlapping time intervals over a clock period). For example, an output of each inductor for each of the plurality of phased regulator sections may generate the common output voltage.

In block 540, provide the common output voltage to a voltage regulator. In one example, the voltage regulator generates a load voltage for a load based on the common output voltage. In one example the voltage regulator generates the load voltage over a plurality of output voltage rails.

In one aspect, one or more of the steps for distributing power from an internal battery as an active energy source in FIG. 5 may be executed by one or more processors which may include hardware, software, firmware, etc. In one aspect, one or more of the steps in FIG. 5 may be executed by one or more processors which may include hardware, software, firmware, etc. The one or more processors, for example, may be used to execute software or firmware needed to perform the steps in the flow diagram of FIG. 14. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in the processing system, external to the processing system, or distributed across multiple entities including the processing system. The computer-readable medium may be embodied in a computer program product. By way of example, a computer program product may include a computer-readable medium in packaging materials. The computer-readable medium may include software or firmware for distributing power from an internal battery as an active energy source. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A power distribution system comprising:
an internal battery to function as an active energy source for a load;
a battery switch coupled to the internal battery;
a power management integrated circuit (PMIC) coupled to the battery switch; and
a direct battery voltage connection coupling the internal battery to the PMIC and bypassing the battery switch.

2. The power distribution system of claim 1, wherein the internal battery comprises an indirect battery voltage connection to the PMIC through the battery switch.

3. The power distribution system of claim 2, wherein the PMIC generates a common output voltage.

4. The power distribution system of claim 3, wherein the common output voltage is generated by using a phased combination of two PMIC input voltages.

5. The power distribution system of claim 4, wherein the two PMIC input voltages comprises a first voltage at the direct battery voltage connection and a second voltage at the indirect battery voltage connection.

6. The power distribution system of claim 5, further comprising a voltage regulator coupled to the PMIC to receive the common output voltage.

7. The power distribution system of claim 6, wherein, based on the common output voltage, the voltage regulator provides a plurality of output voltage rails to the load.

8. A method for distributing power from an internal battery as an active energy source, comprising:
receiving a battery voltage from the internal battery through a direct battery voltage connection;
receiving a primary load voltage from a power conditioner; and
regulating and combining the battery voltage and the primary load voltage using a plurality of phased regulator sections to generate a common output voltage.

9. The method of claim 8, further comprising providing the common output voltage to a voltage regulator.

10. The method of claim 9, wherein the voltage regulator generates a load voltage for a load based on the common output voltage.

11. The method of claim 10, wherein the load voltage is generated over a plurality of output voltage rails.

12. The method of claim 8, wherein the internal battery is charged from an external power supply through a battery switch.

13. The method of claim 12, wherein the direct battery voltage connection bypasses the battery switch.

14. The method of claim 13, wherein the primary load voltage is coupled to the battery switch.

15. The method of claim 8, wherein the plurality of phased regulator sections is active sequentially at different phase durations.

16. The method of claim 8, wherein each of the plurality of phased regulator sections includes one or more of a pair of drivers, a pair of transistors and an inductor.

17. The method of claim 16, wherein the pair of transistors for each of the plurality of phased regulator sections is active sequentially at different phase durations.

18. The method of claim 17, wherein the pair of drivers for each of the plurality of phased regulator sections is active sequentially at the different phase durations.

19. An apparatus for distributing power from an internal battery as an active energy source, the apparatus comprising:
means for receiving a battery voltage from the internal battery through a direct battery voltage connection;
means for receiving a primary load voltage from a power conditioner; and
means for regulating and combining the battery voltage and the primary load voltage using a plurality of phased regulator sections to generate a common output voltage.

20. The apparatus of claim 19, further comprising means for providing the common output voltage to a voltage regulator.

21. The apparatus of claim 20, further comprising means for generating a load voltage for a load based on the common output voltage.

22. The apparatus of claim 21, further comprising a plurality of output voltage rails, and wherein the load voltage is generated over the plurality of output voltage rails.

23. The apparatus of claim 19, further comprising a battery switch and wherein the internal battery is charged from an external power supply through the battery switch.

24. The apparatus of claim 23, wherein the direct battery voltage connection bypasses the battery switch.

25. The apparatus of claim 24, wherein the primary load voltage is coupled to the battery switch.

26. The apparatus of claim 19, wherein the plurality of phased regulator sections is active sequentially at different phase durations.

27. The apparatus of claim 19, wherein each of the plurality of phased regulator sections includes one or more of a pair of drivers, a pair of transistors and an inductor.

28. The apparatus of claim 27, wherein the pair of transistors for each of the plurality of phased regulator sections is active sequentially at different phase durations.

29. The apparatus of claim 28, wherein the pair of drivers for each of the plurality of phased regulator sections is active sequentially at the different phase durations.

30. A computer-readable medium storing computer executable code, operable on a device comprising at least one processor and at least one memory coupled to the at least one processor, wherein the at least one processor is configured to implement distributing power from an internal battery as an active energy source, the computer executable code comprising:
instructions for causing a computer to receive a battery voltage from the internal battery through a direct battery voltage connection, wherein the internal battery is charged from an external power supply through a battery switch and wherein the direct battery voltage connection bypasses the battery switch;
instructions for causing the computer to receive a primary load voltage from a power conditioner; and
instructions for causing the computer to regulate and combine the battery voltage and the primary load voltage using a plurality of phased regulator sections to generate a common output voltage.
